(19) United States
(12) Patent Application Publication
(10) Pub. No.: US 2019/0186532 A1
(43) Pub. Date: Jun. 20, 2019

(54) SINTERED BEARING AND PROCESS FOR PRODUCING SAME

(71) Applicant: NTN CORPORATION, Osaka (JP)

(72) Inventors: Yoshinori ITO, Aichi (JP); Yuta OHASHI, Aichi (JP); Shinji KOMATSUBARA, Mie (JP); Daisuke TAKEDA, Aichi (JP)

(21) Appl. No.: 16/329,256

(22) PCT Filed: Sep. 7, 2017
(86) PCT No.: PCT/JP2017/032364

§ 371 Date: Feb. 28, 2019

(30) Foreign Application Priority Data
Sep. 8, 2016 (JP) 2016-175436
Sep. 21, 2016 (JP) 2016-184290
Sep. 26, 2016 (JP) 2016-187265

(51) Int. Cl. F16C 17/02; B22F 3/10; B22F 5/10; B22F 1/00

(52) U.S. Cl. CPC F16C 17/02; B22F 3/10; B22F 5/106; B22F 1/0011; F16C 2220/20; B22F 2301/35; B22F 2301/10; F16C 2204/10; F16C 2204/60; B22F 2304/10

(57) ABSTRACT

Provided is a sintered bearing, which is obtained by sintering a green compact including: a partially diffusion-alloyed powder (11) in which a copper powder (13) adheres onto a surface of an iron powder (12) through partial diffusion; elemental copper powder; low-melting point metal powder having a lower melting point than copper; and graphite powder. The partially diffusion-alloyed powder (11) has a maximum particle diameter of 106 μm or less, and the copper powder (13) of the partially diffusion-alloyed powder (11) has a maximum particle diameter of 10 μm or less.

### TECHNICAL FIELD

The present invention relates to a sintered bearing and a method of producing the same.

### BACKGROUND ART

A sintered bearing is formed of a sintered compact having inner pores impregnated with a lubricating oil. Along with relative rotation with respect to a shaft to be supported, the lubricating oil impregnated in the sintered compact seeps out onto a sliding part with respect to the shaft to form an oil film, and the sintered bearing is configured to support the shaft in a rotatable manner through intermediation of the oil film.

As the sintered bearing, sintered bearings formed of an iron-based sintered compact and a copper-based sintered compact have been known. The iron-based sintered bearing has high material strength, but is inferior in slidability with respect to the shaft because its material is hard. Meanwhile, the copper-based sintered bearing is excellent in slidability with respect to the shaft because its material is soft, but is inferior in material strength to the iron-based sintered bearing.

In view of the foregoing, a sintered bearing using copper-coated iron powder in which surfaces of particles of iron powder are coated with copper has been known. When the surfaces of the particles of the iron powder are coated with copper as described above, a large part of a bearing surface is formed of copper. With this, the shaft is less liable to be damaged, and smooth sliding is achieved. In addition, a strong skeleton formed mainly of iron is formed under the bearing surface formed mainly of copper, and thus the strength of the bearing is ensured in its entirety.

For example, in Patent Literature 1, there is described a sintered bearing using copper-coated iron powder having a particle size of 80 mesh or less.

### CITATION LIST

Patent Literature 1: JP 3613569 B2

Patent Literature 2: JP 2016-50648 A

### SUMMARY OF INVENTION

### Technical Problem

Such sintered bearing is often used for applications of supporting a rotary shaft configured to rotate at relatively low speed (e.g., at a circumferential speed of 300 m/min or less). However, when a shaft configured to rotate at such a high speed as a circumferential speed of more than 600 m/min is to be supported, it is difficult for the related-art sintered bearing to stably support the shaft.

For example, as a bearing for a small-sized motor, such as a bearing for a fan motor to be mounted to a notebook-type personal computer or the like, a fluid dynamic bearing obtained by forming a plurality of dynamic pressure generating grooves arranged in a herringbone pattern on an inner peripheral surface of a bearing member made of a sintered metal is often used (Patent Literature 2). When the dynamic pressure generating grooves are formed as described above, during rotation of the shaft, the lubricating oil is collected in a partial region on a bearing surface in an axial direction with the dynamic pressure generating grooves to cause a dynamic pressure effect, and the shaft is supported so as not to be brought into contact with the bearing member while rotating by virtue of the dynamic pressure effect.

The dynamic pressure generating grooves on the inner peripheral surface of the bearing member may be formed by, for example, at the time of sizing of a sintered compact, forming a plurality of projections corresponding to the shapes of the dynamic pressure generating grooves on an outer peripheral surface of a core pin, and pressing an inner peripheral surface of the sintered compact against the projections on the outer peripheral surface of the core pin with a pressure in association with the sizing. However, in such step, the dynamic pressure generating grooves are formed through plastic deformation of a sintered material, and hence have a limitation in accuracy to be ensured owing to variation in plastic deformation amount.

Meanwhile, when coarse pores on the bearing surface are reduced, an oil film formation rate is increased. Therefore, it is considered that, even when the dynamic pressure generating grooves are omitted, sufficient oil film stiffness is achieved. As a result, the fluid dynamic bearing including the dynamic pressure generating grooves can be replaced with a so-called circular bearing without such dynamic pressure generating grooves, and it is considered that a reduction in cost of a bearing device can be achieved.

In view of the foregoing, an object of the present invention is to provide a sintered bearing in which coarse pores on a bearing surface are reduced, and surface pores and inner pores are made fine and homogenized.

### Solution to Problem

In order to achieve the above-mentioned object, according to one embodiment of the present invention, there is provided a sintered bearing, comprising a sintered compact comprising: copper-coated iron powder in which a surface of iron powder is coated with copper; and a low-melting point metal (e.g., low-melting point metal powder) having a lower melting point than copper, the iron powder having a particle size of 145 mesh or less.

The “powder having a particle size of 145 mesh or less” refers to powder capable of passing through a sieve having an opening of 145 mesh (about 106 μm) (i.e., powder without particles not capable of passing through the sieve having an opening of 145 mesh). The particle size of the powder is measured by, for example, a laser diffraction scattering method.

As described above, when the sintered bearing is formed by using the copper-coated iron powder, the slidability of the sintered bearing with respect to a shaft is improved through exposure of a large amount of copper on a bearing surface, and besides, the strength of the sintered compact is increased through formation of an iron skeleton as described above. In such sintered bearing, when the iron powder serving as a core of the copper-coated iron powder is made so fine as to achieve a particle size of 145 mesh or less, pores formed in the sintered compact, particularly open pores on the bearing surface are made fine, and the diameters of the pores are uniformized. Thus, the oil film forming capability of the sintered bearing is improved.

Specifically, measurement results of an oil film formation rate of a sintered bearing using copper-coated iron powder comprising iron powder of 100 mesh or less as a core (a comparative product, see the left graph) and an oil film formation rate of a sintered bearing using fine copper-coated iron powder comprising iron powder of 145 mesh or less, specifically 325 mesh or less as a core (a product of the present invention, see the right graph) are shown in FIG. 1. In each of FIG. 1, as a vertical line which extends downward from a horizontal line representing an oil film formation rate of 100% becomes shorter, an oil film formation rate closer to 100% is indicated, and as the vertical line becomes longer, a lower oil film formation rate is indicated. The comparative product has little time to achieve an oil film formation rate of 100%, but the product of the present invention almost always shows an oil film formation rate of 100%. As described above, the product of the present invention has a high oil film formation rate, and hence an oil film is easily uniformly formed on an entire surface of the bearing surface, and can stably support a shaft configured to rotate at high speed. The oil film formation rate may be measured by relatively rotating a shaft and the bearing while applying a voltage therebetween, and measuring a current carrying amount (voltage) therebetween.

In addition, as described above, when the iron powder is sieved with a sieve having a small opening, irregular particles are eliminated, and hence particles of the iron powder each have a relatively near-spherical shape. The copper-coated iron powder comprising such iron particles each having a relatively near-spherical shape as a core has a high degree of fluidity, and can be smoothly filled in a forming mold. With this, particles of raw material powder can be prevented from forming a bridge to form coarse pores, and hence a uniform oil film is more easily formed on the entire surface of the bearing surface.

It is preferred that the iron powder serving as a core of the copper-coated iron powder to be used comprise atomized powder originally having a relatively near-spherical shape.

In order to achieve the above-mentioned object, according to another embodiment of the present invention, there is provided a sintered bearing, which is obtained by sintering a green compact comprising: partially diffusion-alloyed powder in which first copper powder adheres onto a surface of iron powder through partial diffusion; second copper powder; and low-melting point metal powder having a lower melting point than copper, the partially diffusion-alloyed powder having a maximum particle diameter of 106 μm or less, the first copper powder of the partially diffusion-alloyed powder having a maximum particle diameter of 10 μm or less.

In the embodiment of the present invention, the maximum particle diameters of the partially diffusion-alloyed powder and the copper powder (first copper powder) are limited, and besides, the maximum particle diameter of the copper powder is set to 10 μm or less to reduce the particle diameter of the copper powder. Accordingly, the diameters of particles of the partially diffusion-alloyed powder can be uniformized, and thus coarse pores are less liable to be formed after the sintering. Meanwhile, the particle diameter of raw material powder is not excessively reduced, and the raw material powder has satisfactory fluidity at the time of forming the green compact.

When the second copper powder has an irregular shape and a porous form, a sintered compact after the sintering can contract to be smaller than the green compact. Accordingly, a sintered structure is densified, and the generation of coarse pores can be further suppressed.

Even when the sintered bearing according to the embodiment of the present invention comprises a bearing surface formed into a cylindrical shape without a dynamic pressure generating groove, sufficient oil film stiffness can be ensured, and a high oil film formation rate can be achieved. Accordingly, the dynamic pressure generating groove can be omitted, and a reduction in cost of a bearing device can be achieved as compared to the case of using a fluid dynamic bearing with such dynamic pressure generating groove.

According to another embodiment of the present invention, there is provided a method of producing a sintered bearing, comprising sintering a green compact comprising: partially diffusion-alloyed powder in which first copper powder adheres onto a surface of iron powder through partial diffusion; second copper powder; and low-melting point metal powder having a lower melting point than copper to produce a sintered bearing, the partially diffusion-alloyed powder having a maximum particle diameter of 106 μm or less, the first copper powder of the partially diffusion-alloyed powder having a maximum particle diameter of 10 μm or less. In this case, it is preferred that the second copper powder to be used comprise porous copper powder having an irregular shape.

In order to achieve the above-mentioned object, according to another embodiment of the present invention, there is provided a sintered bearing, which is obtained by sintering a green compact comprising: partially diffusion-alloyed powder in which copper powder adheres onto a surface of iron powder through partial diffusion; and copper-based powder including copper as a base, the copper-based powder to be used comprising porous copper alloy powder including copper alloyed with a low-melting point metal having a lower melting point than copper, the partially diffusion-alloyed powder having a maximum particle diameter of 106 μm or less, the copper powder of the partially diffusion-alloyed powder having a maximum particle diameter of 10 μm or less.

In the embodiment of the present invention, the maximum particle diameters of the partially diffusion-alloyed powder and the copper powder are limited, and besides, the maximum particle diameter of the copper powder is set to 10 μm or less to reduce the particle diameter of the copper powder. Accordingly, the diameters of particles of the partially diffusion-alloyed powder can be uniformized, and thus coarse pores are less liable to be formed after the sintering. Meanwhile, the particle diameter of raw material powder is not excessively reduced, and the raw material powder has satisfactory fluidity at the time of forming the green compact.

When the copper alloy powder (e.g., bronze powder) including copper alloyed with a low-melting point metal having a lower melting point than copper is used as the copper-based powder, the generation of coarse pores can be suppressed more effectively. That is, when the low-melting point metal is used as elemental powder, low-melting point metal powder melts in its entirety to form a liquid phase at the time of sintering, and the liquid phase moves to form pores in its original place. Meanwhile, when the copper alloy powder is used, only a surface of the copper alloy powder melts at the time of sintering, and hence the generation of such pores can be prevented. In addition, when the copper alloy powder is used, segregation, which poses a problem in the case of using the low-melting point metal as elemental powder, can also be avoided.

In this connection, powder merely including copper alloyed with the low-melting point metal is generally solid and hard, and hardly deforms. Therefore, gaps are liable to be formed between particles at the time of forming the green compact. This results in the generation of coarse pores after the sintering. Meanwhile, when the porous copper alloy powder, which is softened, is used, the compressibility of the raw material powder is improved, and gaps are less liable to be formed between the particles. Accordingly, the generation of coarse pores can be suppressed after the sintering.

Even when the sintered bearing according to the embodiment of the present invention comprises a bearing surface formed into a cylindrical shape without a dynamic pressure generating groove, sufficient oil film stiffness can be ensured, and a high oil film formation rate can be achieved. Accordingly, the dynamic pressure generating groove can be omitted, and a reduction in cost of a bearing device can be achieved as compared to the case of using a fluid dynamic bearing with such dynamic pressure generating groove.

According to another embodiment of the present invention, there is provided a method of producing a sintered bearing, comprising sintering a green compact comprising: partially diffusion-alloyed powder in which copper powder adheres onto a surface of iron powder through partial diffusion; and copper-based powder including copper as a base to produce a sintered bearing, the copper-based powder to be used comprising porous copper alloy powder including copper alloyed with a low-melting point metal having a lower melting point than copper, the partially diffusion-alloyed powder having a maximum particle diameter of 106 μm or less, the copper powder of the partially diffusion-alloyed powder having a maximum particle diameter of 10 μm or less. The porous copper alloy powder may be obtained by annealing copper alloy powder.

### Advantageous Effects of Invention

As described above, according to the present invention, coarse pores on the bearing surface can be reduced, and surface pores can be made fine and homogenized. With this, pressure relief is less liable to occur on the bearing surface, and hence a high oil film formation rate can be achieved.

### BRIEF DESCRIPTION OF DRAWINGS

FIG. 1 are graphs for showing measurement results of oil film formation rates of a comparative product (left graph) and a product of the present invention (right graph).

FIG. 2 is a sectional view of a sintered bearing.

FIG. 3 is a sectional view of a fan motor.

FIG. 4 is a sectional view of a bearing device for a fan motor.

FIG. 5 is a view for schematically illustrating a form of partially diffusion-alloyed powder.

FIG. 6 is a view obtained by subjecting a micrograph of porous copper powder to binarization processing.

FIG. 7 is a view for schematically illustrating a sintered structure in the present invention.

FIG. 8 is a view for schematically illustrating another example of the partially diffusion-alloyed powder.

FIG. 9 are graphs for showing comparative test results of oil film formation rates.

FIG. 10 is a circuit diagram of a measurement device for an oil film formation rate.

### DESCRIPTION OF EMBODIMENTS

### First Embodiment

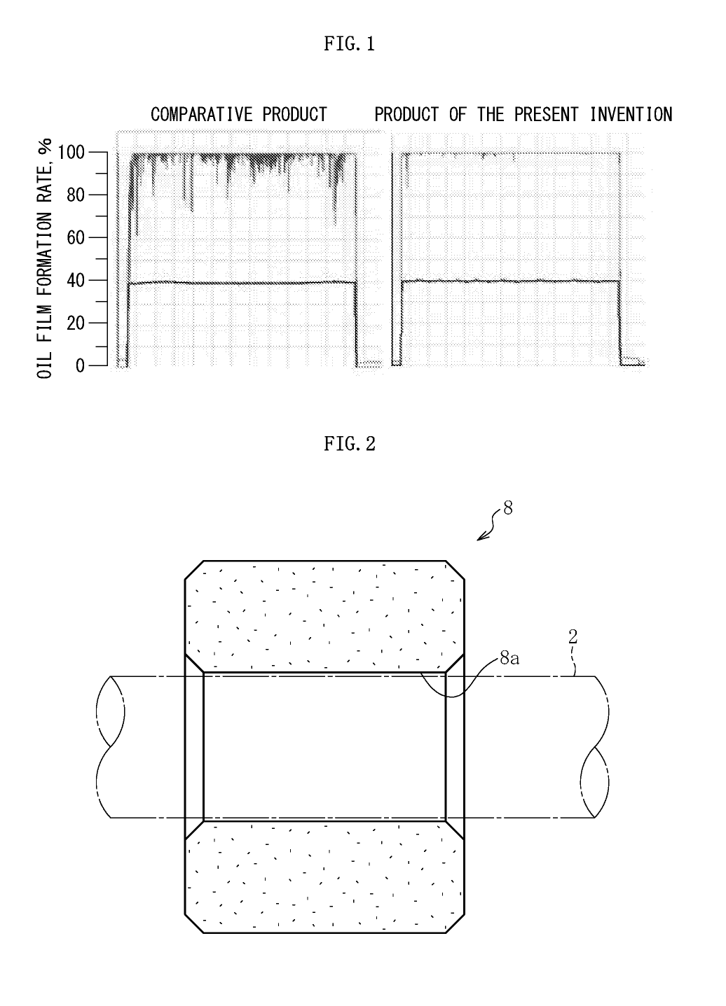

A first embodiment of the present invention is described below with reference to FIG. 1 and FIG. 2.

As illustrated in FIG. 2, a sintered bearing 8 according to this embodiment comprises a sintered compact having a cylindrical shape. The sintered bearing 8 has formed, on an inner peripheral surface 8a thereof, a smooth bearing surface formed into a cylindrical shape without a dynamic pressure generating groove. In this embodiment, the entire inner peripheral surface 8a of the sintered bearing 8 functions as the bearing surface. A shaft 2 is inserted along an inner periphery of the sintered bearing 8.

The sintered compact forming the sintered bearing 8 is formed by filling raw material powder obtained by mixing various powders in a mold, and compressing the raw material powder to form a green compact, followed by sintering the green compact. The raw material powder is mixed powder containing copper-coated iron powder as a main component. For example, the raw material powder contains the copper-coated iron powder at 95 wt % or more.

The copper-coated iron powder is powder in which a surface of iron powder is coated with a copper layer. In this embodiment, the surface of the iron powder is coated with copper by subjecting the iron powder to plating (electrolytic plating or electroless plating). The ratio of copper coating the iron powder is set to, for example, from 20 wt % to 40 wt % with respect to the iron powder. The thickness of copper coating the iron powder is set to, for example, from 0.1 μm to 25 μm.

As the iron powder serving as a core of the copper-coated iron powder, powder of 145 mesh or less, that is, powder capable of passing through a sieve of 145 mesh (having an opening of about 106 μm) is used. In this embodiment, as the iron powder serving as a core of the copper-coated iron powder, for example, powder of 325 mesh or less, that is, powder having passed through a sieve of 325 mesh (having an opening of about 45 μm) is used. As the iron powder, known powders, such as reduced iron powder and atomized iron powder, may be widely used. For example, atomized iron powder having a relatively near-spherical shape may be used.

In general, the reduced iron powder includes a large number of particles each having an irregular shape. However, when the reduced iron powder is caused to pass through a sieve having a small opening as described above, the particles each having an irregular shape are eliminated, and hence particles each having a relatively near-spherical shape remain. Accordingly, it is also appropriate to use the reduced iron powder as the iron powder serving as a core of the copper-coated iron powder. The reduced iron powder is also called sponge iron powder, and particles thereof each have innumerable micropores inside thereof, and hence the reduced iron powder is easily subjected to plastic deformation. Therefore, when the raw material powder containing the reduced iron powder is compressed, the reduced iron powder is easily subjected to plastic deformation to tangle with other particles. As a result, the strength of the green compact, and by extension, the strength of the sintered compact obtained by sintering the green compact can be increased.

Low-melting point metal powder is added as a binder at the time of sintering. As the low-melting point metal powder, metal powder having a lower melting point than copper, particularly metal powder having a melting point of 700° C. or less, for example, tin powder, zinc powder, or phosphorus alloy powder is used. In this embodiment, out of those powders, tin powder, which is easily diffused into copper and iron, and is easily used as elemental powder, particularly atomized tin powder is used. At the time of sintering, the low-melting point metal powder forms a liquid phase and moves to form pores in its original place. Accordingly, in order to make the pores fine, it is preferred to use powder having a small particle size (e.g., powder having a particle size of 145 mesh or less, desirably 250 mesh or less, more desirably 325 mesh or less) as the low-melting point metal powder.

It is also appropriate to use copper alloy powder (e.g., bronze powder) including copper alloyed with a low-melting point metal. However, the copper alloy powder of this kind is generally hard and hardly deforms, and hence gaps are liable to be formed between particles at the time of forming the green compact, which results in coarsening of pores after the sintering. Accordingly, it is preferred to blend elemental powder of the low-melting point metal as described above.

Various molding aids (e.g., a molding lubricant) may be added to the raw material powder as required. In this embodiment, a molding lubricant is blended at from 0.1 wt % to 1.0 wt % with respect to the raw material powder. As the molding lubricant, for example, metal soap (e.g., calcium stearate) or wax may be used. However, it is preferred to reduce the usage amount of the molding lubricant to the extent possible because the molding lubricant is decomposed and disappears through the sintering to cause coarse pores.

In addition, a solid lubricant may be added to the raw material powder. As the solid lubricant, for example, graphite powder may be used. The graphite powder plays a role in lubricating sliding of the sintered bearing with respect to the shaft by being exposed on the bearing surface. However, in the case of a sintered bearing configured to support a shaft rotating at high speed as in this embodiment, there is risk in that foreign matter, such as abrasion powder, tangles with graphite exposed on the bearing surface, and slidability is reduced contrarily. Accordingly, it is sometimes preferred not to blend the solid lubricant particularly in the case of the sintered bearing configured to support a shaft rotating at high speed.

In addition, any other metal powder may be added to the raw material powder. For example, elemental copper powder may be added. As the elemental copper powder, electrolytic copper powder or atomized copper powder may be used.

In this embodiment, the raw material powder consists of the copper-coated iron powder, the tin powder, and the molding lubricant, and does not contain the solid lubricant and any other metal powder. The compositions and blending amounts of the powders are adjusted so that the raw material powder contains copper at a content of from 15 wt % to 40 wt % and the low-melting point metal at a content of from 1 wt % to 4 wt %, with the balance being iron.

The above-mentioned raw material powder is filled in a forming mold and compressed to forma green compact. At this time, when the iron powder contained in the raw material powder is fine, pores to be formed in the green compact are made fine and the diameters of the pores are uniformized. However, when the iron powder is fine as described above, there is a risk in that the raw material powder is not uniformly filled in the mold owing to insufficient fluidity, and coarse pores are formed in the green compact. In this case, a general measure which is frequently used is to increase the width of the particle size distribution of the raw material powder to allow incorporation of larger particles and thus allow penetration of smaller particles into gaps between the larger particles, to thereby prevent the generation of coarse pores.

In the present invention, the particle size of the copper-coated iron powder is somewhat increased by coating the surface of the fine iron powder with copper, and thus the fluidity of the raw material powder is improved without increasing the width of the particle size distribution of the raw material powder. In addition, when the copper-coated iron powder comprising the iron powder having a relatively near-spherical shape as a core is used, the fluidity of the raw material powder is further improved. Thus, the raw material powder containing the fine iron powder having a particle size of 145 mesh or less, preferably 250 mesh or less, more preferably 325 mesh or less can be uniformly filled in the mold, and hence a green compact in which inner pores are fine and the diameters of the pores are uniform can be obtained.

When the above-mentioned green compact is sintered, a sintered compact is obtained. A sintering temperature is set to a temperature which is higher than the melting point of the low-melting point metal and is lower than the melting point of copper, and is specifically set to from about 800° C. to about 900° C. When the green compact is sintered, the tin powder in the green compact forms a liquid phase to wet a surface of the copper layer of the copper-coated iron powder, to thereby promote sintering of copper. In addition, the tin powder having formed the liquid phase plays a role as a binder during the sintering. Thus, the copper-coated iron powders, and an iron particle and the copper layer of the copper-coated iron powder are firmly bonded to each other. In this embodiment, the raw material powder and a sintering atmosphere do not contain carbon, and the sintering temperature is set to 900° C. or less, and hence an iron structure of the sintered compact is entirely formed of a ferrite phase.

For example, the sintered compact has a density of from 6.0 g/cm³ to 7.2 g/cm³ (preferably from 6.9 g/cm³ to 7.2 g/cm³) and an open porosity of from 5% to 20% (preferably from 6% to 18%). An oil is impregnated into inner pores of the sintered compact. For example, an oil having a kinematic viscosity at 40° C. of from 10 mm²/sec to 200 mm²/sec, preferably from 10 mm²/sec to 60 mm²/sec, and a viscosity index of from 100 to 250 is used. Thus, the sintered bearing 8 of this embodiment is completed. The open porosity is measured by a method described in JIS Z2501:2000.

In the sintered bearing 8 of this embodiment, inner pores, particularly open pores on the bearing surface are made fine and the diameters of the pores are uniformized. Thus, an oil film is easily formed on the entire bearing surface at the time of rotation of the shaft 2. Therefore, even when the shaft 2 rotates at high speed (e.g., at a circumferential speed of 600 m/min or more), the oil film can be continuously formed in a bearing gap between the inner peripheral surface 8a of the sintered bearing 8 and an outer peripheral surface of the shaft 2 along the entire circumference of the bearing gap, and hence the shaft 2 can be stably supported.

In the above-mentioned embodiment, the case in which the present invention is applied to the sintered bearing configured to support a shaft rotating at high speed has been described, but as a matter of course, the present invention is also applicable to a sintered bearing configured to support a shaft having a normal rotation speed (e.g., about 300 m/min).

In addition, the sintered bearing of the present invention is applicable not only to a case in which a shaft is configured to rotate, but also to a case in which the shaft is fixed and the sintered bearing is configured to rotate.

### Second Embodiment

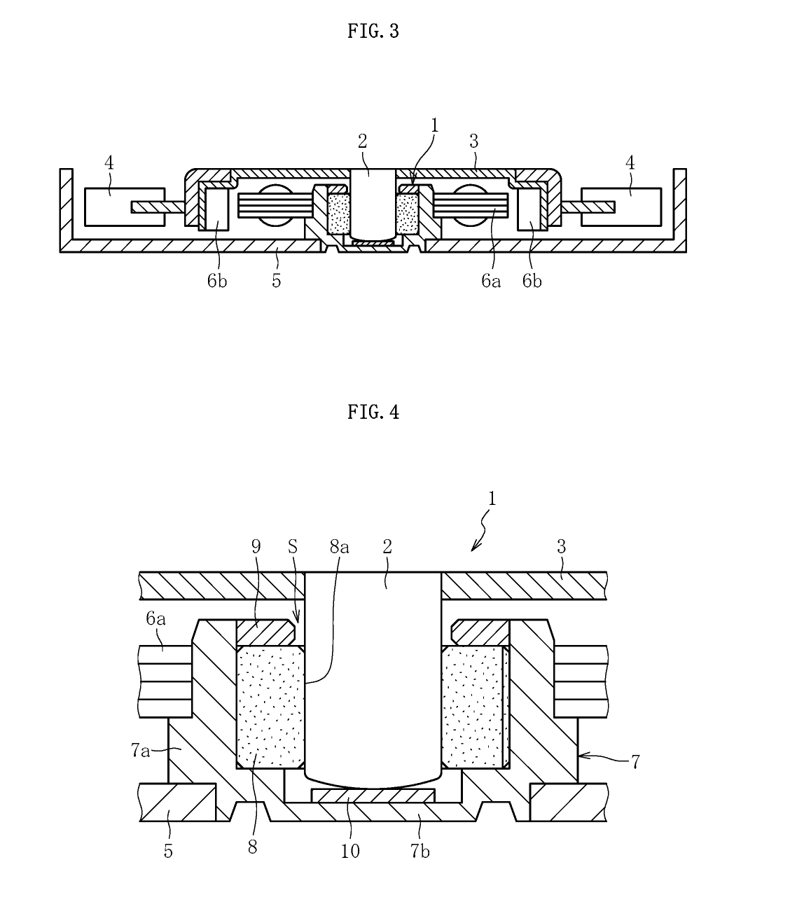

A second embodiment of the present invention is described below with reference to FIG. 3 to FIG. 8.

A fan motor for cooling to be incorporated in an information device, particularly a mobile device, such as a cellular phone or a tablet terminal, is illustrated in FIG. 3. The fan motor comprises: a bearing device 1; a rotor 3 mounted to a shaft member 2 of the bearing device 1; a vane 4 mounted to a radially outer end of the rotor 3; a stator coil 6a and a rotor magnet 6b opposed to each other across a radial gap; and a casing 5 configured to house these components. The stator coil 6a is mounted to an outer periphery of the bearing device 1, and the rotor magnet 6b is mounted to an inner periphery of the rotor 3. When the stator coil 6a is energized, the rotor 3, the vane 4, and the shaft member 2 are rotated in an integrated manner to cause an air flow in an axial direction or in a radially outer direction.

As illustrated in FIG. 4, the bearing device 1 comprises : the shaft member 2; a housing 7; the sintered bearing 8; a sealing member 9; and a thrust bearing 10.

The shaft member 2 is formed of a metal material, such as stainless steel, into a columnar shape, and is inserted along an inner peripheral surface of the sintered bearing 8 having a cylindrical shape. The shaft member 2 is rotatably supported in a radial direction by the inner peripheral surface 8a of the sintered bearing 8 serving as a bearing surface. A lower end of the shaft member 2 is brought into contact with the thrust bearing 10 arranged at a bottom 7b of the housing 7, and at the time of rotation of the shaft member, the shaft member 2 is supported in a thrust direction by the thrust bearing 10. The housing 7 comprises: a side 7a having a substantially cylindrical shape; and the bottom 7b configured to close a lower opening of the side 7a. The casing 5 and the stator coil 6a are fixed to an outer peripheral surface of the side 7a, and the sintered bearing 8 is fixed to an inner peripheral surface of the side 7a. The sealing member 9 is formed of a resin or a metal into a ring shape, and is fixed to an upper end of the inner peripheral surface of the side of the housing. A lower end surface of the sealing member 9 abuts on an upper end surface of the sintered bearing 8 in the axial direction. An inner peripheral surface of the sealing member 9 is opposed to an outer peripheral surface of the shaft member 2 in the radial direction, and a seal space S is formed therebetween. In such bearing device 1, at least a radial gap formed between the inner peripheral surface of the sintered bearing 8 and the outer peripheral surface of the shaft member 2 is filled with a lubricating oil. In addition, the entire inner space of the housing 7 may be filled with the lubricating oil (in this case, an oil surface is formed in the seal space S).

The sintered bearing 8 is formed of an iron-copper-based sintered compact comprising iron and copper as main components. The sintered compact is produced by supplying raw material powder obtained by mixing various powders into a mold, and compressing the raw material powder to forma green compact, followed by sintering the green compact. The raw material powder to be used in this embodiment is mixed powder containing partially diffusion-alloyed powder and elemental copper powder as main raw materials, and having blended therein a low-melting point metal and a solid lubricant. The above-mentioned powders are described in detail below.

[Partially Diffusion-alloyed Powder]

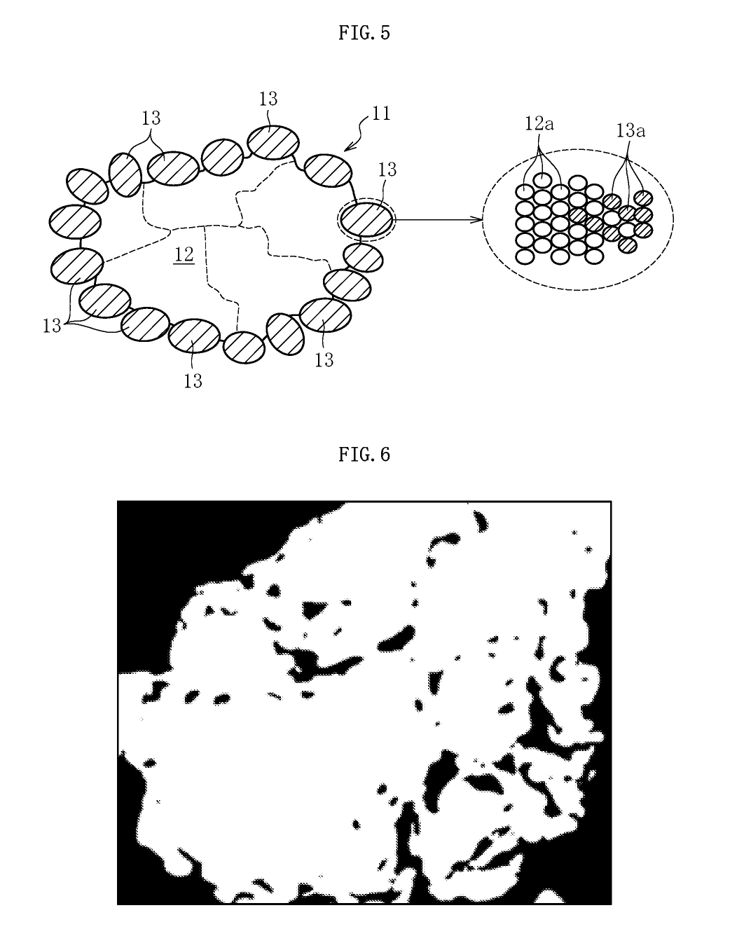

As illustrated in FIG. 5, Fe—Cu partially diffusion-alloyed powder in which a copper powder 13 (first copper powder) having a smaller particle diameter than an iron powder 12 adheres onto a surface of the iron powder 12 serving as a core through partial diffusion is used as a partially diffusion-alloyed powder 11. A partial diffusion portion of the partially diffusion-alloyed powder 11 forms an Fe—Cu alloy, and this alloy portion has a crystalline structure in which iron atoms 12a and copper atoms 13a are bonded to each other and arranged.

For example, reduced iron powder or atomized iron powder may be used as the iron powder 12 of the partially diffusion-alloyed powder 11, but in this embodiment, the reduced iron powder is used. The reduced iron powder has an irregular shape and has a sponge-like form (porous form) with inner pores. When the reduced iron powder is used, compressibility is improved, and thus formability can be improved as compared to a case of using the atomized iron powder. In addition, there is another advantage in that an iron structure after the sintering has a porous form, and hence a lubricating oil can be also retained in the iron structure, with the result that an oil retention property of the sintered compact can be improved. Further, adhesiveness of the copper powder to the iron powder is increased, and hence partially diffusion-alloyed powder having a uniform copper concentration can be obtained.

In addition, powder having a particle size of 145 mesh or less is used as the iron powder 12 serving as a core of the partially diffusion-alloyed powder 11. Herein, the “particle size of 145 mesh” means powder having passed through a sieve having an opening of 145 mesh (about 106 μm). Accordingly, in this case, the maximum particle diameter of the iron powder is 106 μm. The “having a particle size of 145 mesh or less” means that the powder has a particle size of 145 mesh or less, that is, the powder has a maximum particle diameter of 106 μm or less. The particle size of the iron powder 12 is preferably set to 230 mesh (an opening of 63 μm, a maximum particle diameter of 63 μm) or less. The particle diameter of the powder may measured by, for example, a laser diffraction scattering method (the same applies hereinafter).

In addition, both electrolytic copper powder and atomized copper powder may be used as the copper powder 13 (first copper powder) of the partially diffusion-alloyed powder 11, but the electrolytic copper powder is preferably used. In general, the electrolytic copper powder has a dendritic form, and hence when the electrolytic copper powder is used as the copper powder 13, there is an advantage in that the sintering easily proceeds at the time of sintering. In addition, the maximum particle diameter of the copper powder 13 of the partially diffusion-alloyed powder 11 is set to 10 μm or less. The ratio of the Cu powder in the partially diffusion-alloyed powder 11 is set to from 10 mass % to 30 mass % (preferably from 15 mass % to 25 mass %).

Powder having a particle size of 145 mesh or less (having a maximum particle diameter of 106 μm or less) is used as the partially diffusion-alloyed powder 11 described above.

[Elemental Copper Powder]

Copper powder which is porous both on its surface and in an inside thereof as shown in FIG. 6 (in FIG. 6, a black portion which appears in a white background represents a pore) is used as the elemental copper powder (second copper powder). Such porous copper powder may be obtained by annealing copper powder. The particle diameter of the elemental copper powder is comparable to the particle diameter of the iron powder 12 of the partially diffusion-alloyed powder. Specifically, the elemental copper powder has a particle size of 145 mesh or less (a maximum particle diameter of 106 μm or less), and preferably has a particle size of 230 mesh or less (a maximum particle diameter of 63 μm or less).

As the elemental copper powder, the above-mentioned porous copper powder may be used together with foil-like copper powder having been flattened so as to have an aspect ratio of, for example, 13 or more. The foil-like copper powder is easily exposed on a surface of the green compact at the time of forming, and hence the surface of the sintered compact including the bearing surface can be easily formed of a copper film.

[Low-Melting Point Metal Powder]

The low-melting point metal powder is added as a binder at the time of sintering. As the low-melting point metal powder, metal powder having a lower melting point than copper, particularly metal powder having a melting point of 700° C. or less, for example, tin powder, zinc powder, or phosphorus powder is used. In this embodiment, out of those powders, tin powder, which is easily diffused into copper and iron and easily used as elemental powder, particularly atomized tin powder is used. At the time of sintering, the low-melting point metal powder forms a liquid phase and moves to form pores in its original place. Accordingly, in order to make the pores fine, it is preferred to use powder having a small particle size, for example, a particle size of 250 mesh or less (a maximum particle diameter of 63 μm or less), preferably a particle size of 350 mesh or less (a maximum particle diameter of 45 μm or less) as the low-melting point metal powder.

It is also appropriate to use copper alloy powder (e.g., bronze powder) including copper alloyed with a low-melting point metal.

[Solid Lubricant]

As the solid lubricant, one kind or two or more kinds of graphite powder, molybdenum disulfide powder, and the like may be used. In this embodiment, graphite powder, particularly flake graphite powder is used in consideration of cost. Solid lubricant powder plays a role in lubricating sliding with the shaft member 2 when exposed on the bearing surface 8a.

The raw material powder described above has a composition comprising 10 mass % or more and 50 mass % or less (preferably 20 mass % or more and 30 mass % or less) of the elemental copper powder, 1 mass % to 4 mass % of the low-melting point metal powder, and 0.1 mass % to 1.5 mass % of carbon, with the balance being the partially diffusion-alloyed powder. Various molding aids (e.g., a molding lubricant) may be added to the raw material powder as required. In this embodiment, a molding lubricant is blended at from 0.1 mass % to 1.0 mass % with respect to 100% of the raw material powder. As the molding lubricant, for example, metal soap (e.g., calcium stearate) or wax may be used. However, it is preferred to reduce the usage amount of the molding lubricant to the extent possible because the molding lubricant is decomposed and disappears through the sintering to cause coarse pores.

The above-mentioned raw material powder is filled in a mold and compressed to form a green compact. After that, when the green compact is sintered, a sintered compact is obtained. A sintering temperature is set to a temperature which is equal to or higher than the melting point of the low-melting point metal and is equal to or lower than the melting point of copper, and is specifically set to from about 760° C. to about 900° C. When the green compact is sintered, the tin powder in the green compact forms a liquid phase to wet a surface of the copper powder (first copper powder) on the surface of the partially diffusion-alloyed powder or a surface of the elemental copper powder (second copper powder). Thus, sintering between copper particles and between a copper particle and an iron particle is promoted.

For example, the sintered compact has a density of from 6.0 g/cm³ to 7.4 g/cm³ (preferably from 6.9 g/cm³ to 7.3 g/cm³) and an inner porosity of from 4% to 20%, preferably from 4% to 12% (more preferably from 5% to 11%). In addition, the contents of the respective elements in the sintered compact are as follows: the content of copper is from 30 mass % to 60 mass %, the content of the low-melting point metal is from 1 mass % to 4 mass %, and the content of carbon is from 0.1 mass % to 1.5 mass %, with the balance being iron.

When the sintered compact is subjected to shaping through sizing, the circularity of the bearing surface can be improved to 1 μm or less. After that, a lubricating oil is impregnated into inner pores of the sintered compact by, for example, a vacuum impregnation method, and thus the sintered bearing 8 (oil-impregnated sintered bearing) illustrated in FIG. 4 is completed. For example, a lubricating oil having a kinematic viscosity at 40° C. of from 10 mm²/sec to 200 mm²/sec, preferably from 10 mm²/sec to 60 mm²/sec, and a viscosity index of from 100 to 250 is used.

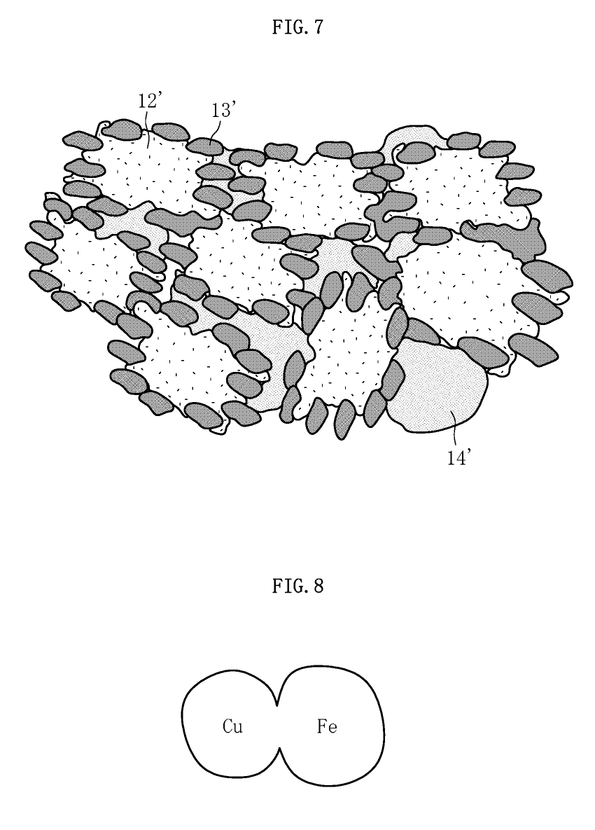

As illustrated in FIG. 7, a sintered structure of the sintered compact has a form in which a Cu structure 13′ (represented by dark gray) derived from the copper powder 13 of the partially diffusion-alloyed powder 11 and a copper structure 14′ (represented by light gray) derived from the elemental copper powder coexist around an Fe structure 12′ (represented by a dotted pattern) derived from the iron powder 12 of the partially diffusion-alloyed powder 11. With this, a form in which a large number of iron structures 12′ are coated with the copper structures 13′ and 14′ is achieved, and hence the exposure amount of the iron structure 12′ on the bearing surface can be reduced. Thus, the initial running-in property of the sintered bearing 8 can be improved. Such sintered structure in which a periphery of the iron structure is coated with the copper structures may be obtained by using copper-coated iron powder including iron powder plated with copper. However, in the case of using the copper-coated iron powder, neck strength between the copper structure and the iron structure after the sintering is lower than in the Fe—Cu partially diffusion-alloyed powder to be used in the present invention, and hence the radial crushing strength of the sintered bearing is significantly reduced.

In a production process for the Fe—Cu partially diffusion-alloyed powder, unless the maximum particle diameters of the iron powder 12 and the copper powder 13 are limited as described above, the partially diffusion-alloyed powder is produced under a state in which iron powder having a large particle diameter and copper powder having a large particle diameter are mixed therein, even when values for the average particle diameters of the iron powder 12 and the copper powder 13 are close to the above-mentioned maximum particle diameters. Therefore, as schematically illustrated in FIG. 8, particles (coarse particles) in each of which the iron powder having a large particle diameter and the copper powder having a large particle diameter are integrated with each other are formed in a considerable amount. When the sintering is performed under a state in which such coarse particles aggregate, gaps between the particles are increased in size, and hence coarse pores are formed after the sintering.

Meanwhile, in the present invention, the maximum particle diameter of the copper powder 13, and further, the maximum particle diameter of the partially diffusion-alloyed powder are limited. Besides, the maximum particle diameter of the copper powder 13 is much smaller than the maximum particle diameter of the partially diffusion-alloyed powder 12. Accordingly, the partially diffusion-alloyed powder has a sharp particle size distribution (in a state in which the diameters of particles of the partially diffusion-alloyed powder are uniform). Meanwhile, the particle diameter of the raw material powder is not excessively reduced, and the raw material powder has satisfactory fluidity in a powder state. Therefore, coarse pores are less liable to be formed after the sintering, and pores in the sintered structure can be made fine and homogenized.

In addition, in the present invention, the porous copper powder is used as the elemental copper powder. According to investigations made by the inventors of the present invention, it has been revealed that, through the use of the porous copper powder (including porous Cu—Sn alloy powder), the sintered compact after the sintering contracts to be smaller than the green compact. Specifically, the dimensional change ratios of the sintered compact to the green compact in terms of inner diameter and outer diameter are both from about 0.995 to about 0.999. This is presumably because the porous copper powder has an action of attracting surrounding copper particles (the copper powder of the partially diffusion-alloyed powder and other porous copper powders) at the time of sintering. Meanwhile, it is usually the case that an existing copper-iron-based sintered compact using non-porous copper powder expands with respect to the state of the green compact at the time of sintering. When the sintered compact contracts at the time of sintering as described above, the sintered structure is densified, and hence the generation of coarse pores can be suppressed more reliably.

By those actions, a sintered compact in which surface pores each have an area of 0.005 mm² or less can be obtained, and the generation of coarse pores can be prevented. Incidentally, a surface porosity on the bearing surface is 4% or more and 15% or less in terms of area ratio. In addition, the oil permeability of the sintered compact is from 0.05 g/10 min to 0.025 g/10 min. The “oil permeability” as used herein is a parameter [unit: g/10 min] which quantitatively indicates how much a porous work piece allows the lubricating oil to flow through its porous structure. The oil permeability may be determined by, under an environment at room temperature (from 26° C. to 27° C.), filling inner peripheral pores of a cylindrical test piece with a lubricating oil while applying a pressure at 0.4 MPa thereto, and collecting an oil having seeped and dropped out of surface open pores on a radially outer surface of the test piece.

As described above, according to the present invention, coarse pores formed on the bearing surface can be eliminated (the maximum area of surface pores is 0.005 mm²) , and the sizes of surface pores can be uniformized. With this, pressure relief on the bearing surface 8a is suppressed, and an oil film formation rate can be increased. Thus, the sintered bearing can ensure high oil film stiffness and can stably support a shaft irrespective of whether the shaft is configured to rotate at low speed or at high speed. Therefore, even when the sintered bearing has a form of a circular bearing without a dynamic pressure generating groove, bearing performance comparable to that of a sintered bearing with a dynamic pressure generating groove can be achieved, and the sintered bearing can be used as an alternative to the sintered bearing with a dynamic pressure generating groove. In particular, while it is difficult to use the sintered bearing with a dynamic pressure generating groove in a region of a circumferential speed of 5 m/min or less because a sufficient dynamic pressure effect is not obtained, the sintered bearing of the present invention has the merit of being capable of stably supporting the shaft in a low speed region of a circumferential speed of 5 m/min or less.

In addition, in each of the coarse particles illustrated in FIG. 8, the area of a diffusion-bonded portion becomes smaller with respect to the volume of the copper powder, and hence bonding strength between the copper powder and the iron powder is reduced. Therefore, when the partially diffusion-alloyed powder is sieved, the copper particles are liable to be escaped from the iron particles through an impact. In this case, a state in which elemental copper powder having a small particle diameter is mixed in a large amount in the raw material powder is achieved, and hence the fluidity of the raw material powder is reduced, which results in segregation of copper. Meanwhile, in the present invention, the maximum particle diameter of the copper powder 13 to be used for production of the partially diffusion-alloyed powder is limited, and hence the partially diffusion-alloyed powder has the form illustrated in FIG. 5 as a whole. In this case, the area of a diffusion-bonded portion becomes relatively large with respect to the volume of the copper powder 13, and hence bonding strength between the iron powder 12 and the copper powder 13 is increased. Accordingly, the copper powder is less liable to be escaped even through sieving, and the above-mentioned disadvantage can be prevented.

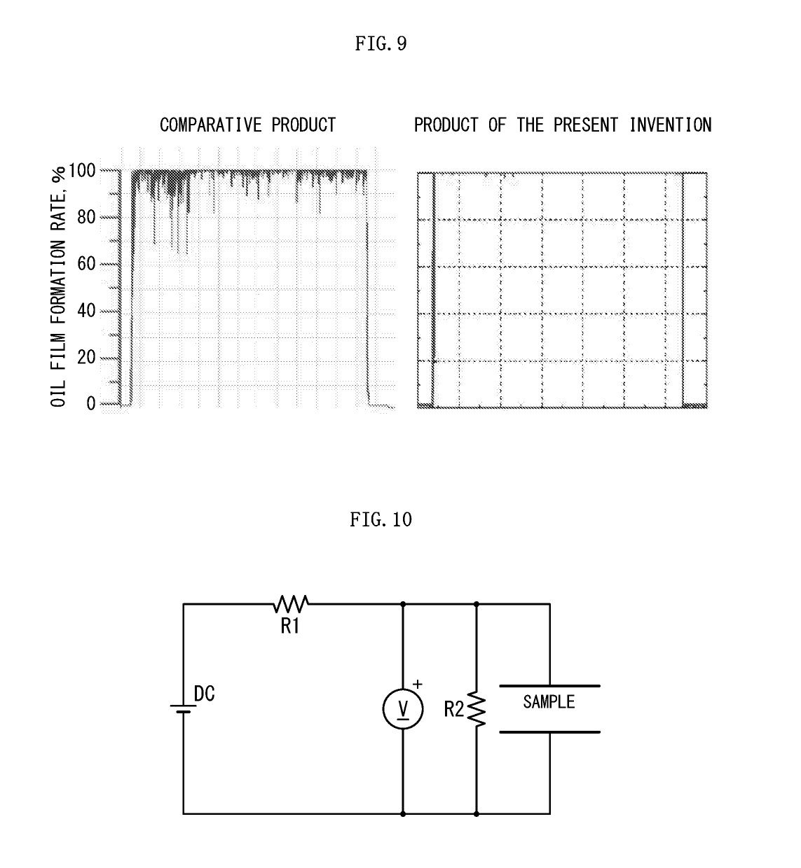

Measurement results of an oil film formation rate of a product of the present invention and an oil film formation rate of a comparative product are shown in FIG. 9. As the comparative product, a sintered bearing obtained by using copper-coated iron powder comprising iron powder of 100 mesh or less as a core is used.

The oil film formation rate is determined by using a circuit illustrated in FIG. 10, setting a combination of a shaft and a sintered bearing as a sample thereto, and measuring a voltage therebetween. When a detection voltage is 0 [V], the oil film formation rate is 0%, and when the detection voltage is equal to a source voltage, the oil film formation rate is 100%. An oil film formation rate of 100% means that the shaft and the sintered bearing are in a non-contact state, and an oil film formation rate of 0% means that the shaft and the sintered bearing are brought into contact with each other. In each of FIG. 9, time is shown on the abscissa. The measurement conditions are set as follows: a rotation speed of the shaft of 2,000 min⁻¹; and a thrust load on the shaft of 0.2 N.

As apparent also from FIG. 9, while it is considered that the shaft and the sintered bearing are frequently brought into contact with each other in the comparative product, the product of the present invention almost always maintains a non-contact state. Accordingly, it has been confirmed that the product of the present invention achieves a higher oil film formation rate than the comparative product.

While the fan motor has been described as an usage example of the sintered bearing according to the present invention, an application object of the sintered bearing according to the present invention is not limited thereto, and the sintered bearing according to the present invention can be used for various applications.

In addition, while a case in which a dynamic pressure generating groove is not formed on the inner peripheral surface of the bearing surface 8a of the sintered bearing 8 has been described, a plurality of dynamic pressure generating grooves may be formed on the bearing surface 8a as required. The dynamic pressure generating grooves may be formed on an outer peripheral surface of the shaft 2.

### Third Embodiment

A third embodiment of the present invention is described below with reference to FIG. 4 to FIG. 7. This embodiment is the same as the above-mentioned second embodiment except for the composition of raw material powder of a sintered bearing 8. Therefore, the configuration of the sintered bearing 8 and a production method therefor are mainly described, and the description of other points is omitted.

The sintered bearing 8 is formed of an iron-copper-based sintered compact comprising iron and copper as main components. The sintered compact is produced by supplying raw material powder obtained by mixing various powders into a mold, and compressing the raw material powder to forma green compact, followed by sintering the green compact. The raw material powder to be used in this embodiment is mixed powder containing partially diffusion-alloyed powder and copper-based powder including copper as a base as main raw materials, and having blended therein a solid lubricant. The above-mentioned powders are described in detail below.

[Partially Diffusion-alloyed Powder]

As illustrated in FIG. 5, Fe—Cu partially diffusion-alloyed powder in which a copper powder 13 (pure copper powder) having a smaller particle diameter than an iron powder 12 adheres onto a surface of the iron powder 12 serving as a core through partial diffusion is used as a partially diffusion-alloyed powder 11. A partial diffusion portion of the partially diffusion-alloyed powder 11 forms an Fe—Cu alloy, and this alloy portion has a crystalline structure in which iron atoms 12a and copper atoms 13a are bonded to each other and arranged.

For example, reduced iron powder or atomized iron powder may be used as the iron powder 12 of the partially diffusion-alloyed powder 11, but in this embodiment, the reduced iron powder is used. The reduced iron powder has an irregular shape and has a sponge-like form (porous form) with inner pores. When the reduced iron powder is used, compressibility is improved, and thus formability can be improved as compared to a case of using the atomized iron powder. In addition, there is another advantage in that an iron structure after the sintering has a porous form, and hence a lubricating oil can be also retained in the iron structure, with the result that an oil retention property of the sintered compact can be improved. Further, adhesiveness of the copper powder to the iron powder is increased, and hence partially diffusion-alloyed powder having a uniform copper concentration can be obtained.

In addition, powder having a particle size of 145 mesh or less is used as the iron powder 12 serving as a core of the partially diffusion-alloyed powder 11. Herein, the “particle size of 145 mesh” means powder having passed through a sieve having an opening of 145 mesh (about 106 μm). Accordingly, in this case, the maximum particle diameter of the iron powder is 106 μm. The “having a particle size of 145 mesh or less” means that the powder has a particle size of 145 mesh or less, that is, the powder has a maximum particle diameter of 106 μm or less. The particle size of the iron powder 12 is preferably set to 230 mesh (an opening of 63 μm, a maximum particle diameter of 63 μm) or less. The particle diameter of the powder may measured by, for example, a laser diffraction scattering method (the same applies hereinafter).

In addition, both electrolytic copper powder and atomized copper powder may be used as the copper powder 13 of the partially diffusion-alloyed powder 11, but the electrolytic copper powder is preferably used. In general, the electrolytic copper powder has a dendritic form, and hence when the electrolytic copper powder is used as the copper powder 13, there is an advantage in that the sintering easily proceeds at the time of sintering. In addition, the maximum particle diameter of the copper powder 13 of the partially diffusion-alloyed powder 11 is set to 10 μm or less. The ratio of the Cu powder in the partially diffusion-alloyed powder 11 is set to from 10 mass % to 30 mass % (preferably from 15 mass % to 25 mass %).

Powder having a particle size of 145 mesh or less (having a maximum particle diameter of 106 μm or less) is used as the partially diffusion-alloyed powder 11 described above.

[Copper-Based Powder]

As the copper-based powder, porous copper alloy powder including copper alloyed with a low-melting point metal is used.

The low-melting point metal functions as a binder at the time of sintering, and a metal having a lower melting point than copper, particularly a metal having a melting point of 700° C. or less, for example, tin, zinc, or phosphorus is used. Of those, tin has a feature of being easily diffused into copper and iron, and hence in this embodiment, the copper alloy powder is formed of bronze powder (Cu—Sn alloy powder) using tin as the low-melting point metal. The particle diameter of the copper alloy powder is comparable to the particle diameter of the iron powder 12 of the partially diffusion-alloyed powder. Specifically, the copper alloy powder has a particle size of 145 mesh or less (a maximum particle diameter of 106 μm or less), and preferably has a particle size of 230 mesh or less (a maximum particle diameter of 63 μm or less).

In addition, copper alloy powder which is porous both on its surface and in an inside thereof as shown in FIG. 6 (in FIG. 6, a black portion which appears in a white background represents a pore) is used as the copper alloy powder. Such porous copper alloy powder may be obtained by annealing copper alloy powder. While copper powder which is made porous through similar treatment is shown in FIG. 6, also the copper alloy powder is in a state of being made porous in a similar form thereto.

[Solid Lubricant]

As the solid lubricant, one kind or two or more kinds of graphite powder, molybdenum disulfide powder, and the like may be used. In this embodiment, graphite powder, particularly flake graphite powder is used in consideration of cost. Solid lubricant powder plays a role in lubricating sliding with the shaft member 2 when exposed on the bearing surface 8a.

The raw material powder described above has a composition comprising 10 mass % or more and 50 mass % or less (preferably 20 mass % or more and 30 mass % or less) of the copper alloy powder and 0.1 mass % to 1.5 mass % of carbon, with the balance being the partially diffusion-alloyed powder. The ratio of the low-melting point metal in the raw material powder is preferably from 1 mass % to 4 mass %. Various molding aids (e.g., a molding lubricant) may be added to the raw material powder as required. In this embodiment, a molding lubricant is blended at from 0.1 mass % to 1.0 mass % with respect to 100% of the raw material powder. As the molding lubricant, for example, metal soap (e.g., calcium stearate) or wax may be used. However, it is preferred to reduce the usage amount of the molding lubricant to the extent possible because the molding lubricant is decomposed and disappears through the sintering to cause coarse pores.

The above-mentioned raw material powder is filled in a mold and compressed to form a green compact. After that, when the green compact is sintered, a sintered compact is obtained. A sintering temperature is set to a temperature which is equal to or higher than the melting point of the low-melting point metal and is equal to or lower than the melting point of copper, and is specifically set to from about 760° C. to about 900° C. When the green compact is sintered, the surface of the copper alloy powder in the green compact forms a liquid phase to wet a surface of the copper powder (first copper powder) on the surface of the partially diffusion-alloyed powder or surfaces of other copper alloy powders. Thus, sintering between copper particles and between a copper particle and an iron particle is promoted.

For example, the sintered compact has a density of from 6.0 g/cm³ to 7.4 g/cm³ (preferably from 6.9 g/cm³ to 7.3 g/cm³) and an inner porosity of from 4% to 20%, preferably from 4% to 12% (more preferably from 5% to 11%). In addition, the contents of the respective elements in the sintered compact are as follows: the content of copper is from 30 mass % to 60 mass %, the content of the low-melting point metal is from 1 mass % to 4 mass %, and the content of carbon is from 0.1 mass % to 1.5 mass %, with the balance being iron.

When the sintered compact is subjected to shaping through sizing, the circularity of the bearing surface can be improved to 1 μm or less. After that, a lubricating oil is impregnated into inner pores of the sintered compact by, for example, a vacuum impregnation method, and thus the sintered bearing 8 (oil-impregnated sintered bearing) illustrated in FIG. 4 is completed. For example, a lubricating oil having a kinematic viscosity at 40° C. of from 10 mm²/sec to 200 mm²/sec, preferably from 10 mm²/sec to 60 mm²/sec, and a viscosity index of from 100 to 250 is used.

As illustrated in FIG. 7, a sintered structure of the sintered compact has a form in which a Cu structure 13′ (represented by dark gray) derived from the copper powder 13 of the partially diffusion-alloyed powder 11 and a copper structure 14′ (represented by light gray) derived from the copper alloy powder coexist around an Fe structure 12′ (represented by a dotted pattern) derived from the iron powder 12 of the partially diffusion-alloyed powder 11. With this, a form in which a large number of iron structures 12′ are coated with the copper structures 13′ and 14′ is achieved, and hence the exposure amount of the iron structure 12′ on the bearing surface can be reduced. Thus, the initial running-in property of the sintered bearing 8 can be improved. Such sintered structure in which a periphery of the iron structure is coated with the copper structures may be obtained by using copper-coated iron powder including iron powder plated with copper. However, in the case of using the copper-coated iron powder, neck strength between the copper structure and the iron structure after the sintering is lower than in the Fe—Cu partially diffusion-alloyed powder to be used in the present invention, and the radial crushing strength of the sintered bearing is significantly reduced.

In the present invention, the maximum particle diameter of the copper powder 13, and further, the maximum particle diameter of the partially diffusion-alloyed powder are limited. Besides, the maximum particle diameter of the copper powder 13 is much smaller than the maximum particle diameter of the partially diffusion-alloyed powder. Accordingly, the partially diffusion-alloyed powder has a sharp particle size distribution (in a state in which the diameters of particles of the partially diffusion-alloyed powder are uniform). Meanwhile, the particle diameter of the raw material powder is not excessively reduced, and the raw material powder has satisfactory fluidity in a powder state. Therefore, coarse pores are less liable to be formed after the sintering, and pores in the sintered structure can be made fine and homogenized.

In addition, in the present invention, the copper alloy powder including copper alloyed with the low-melting point metal having a lower melting point than copper is used as the copper-based powder, and hence the generation of coarse pores can be suppressed more effectively. That is, when elemental powder of the low-melting point metal is blended in the raw material powder, low-melting point metal powder melts in its entirety to form a liquid phase at the time of sintering, and the liquid phase moves to form pores in its original place, which results in the generation of coarse pores. Meanwhile, when the copper alloy powder is used, only a surface of the copper alloy powder melts at the time of sintering, and hence the generation of such pores can be prevented. In addition, when the copper alloy powder is used, segregation, which poses a problem in the case of using the elemental powder of the low-melting point metal, can also be avoided.

In this connection, powder merely including copper alloyed with the low-melting point metal is generally solid and hard, and hardly deforms. Therefore, gaps are liable to be formed between particles at the time of forming the green compact. This results in the generation of coarse pores after the sintering. Meanwhile, when the porous copper alloy powder, which is softened, is used, the compressibility of the raw material powder is improved, and gaps are less liable to be formed between the particles, with the result that the generation of coarse pores can be suppressed after the sintering.

In addition, according to investigations made by the inventors of the present invention, it has been revealed that, through the use of the porous copper alloy powder as the copper-based powder, the sintered compact after the sintering contracts to be smaller than the green compact. Specifically, the dimensional change ratios of the sintered compact to the green compact in terms of inner diameter and outer diameter are both from about 0.995 to about 0.999. This is presumably because the porous copper alloy powder has an action of attracting surrounding copper particles (the copper powder of the partially diffusion-alloyed powder and other copper alloy powders) at the time of sintering. Meanwhile, it is usually the case that an existing copper-iron-based sintered compact using non-porous copper alloy powder expands with respect to the state of the green compact at the time of sintering. When the sintered compact contracts at the time of sintering as described above, the sintered structure is densified, and hence the generation of coarse pores can be suppressed more reliably.

### REFERENCE SIGNS LIST

1 bearing device
2 shaft member
8 sintered bearing
8a inner peripheral surface (bearing surface)
11 partially diffusion-alloyed powder
12 iron powder
13 copper powder

1. A sintered bearing, which is obtained by sintering a green compact comprising: partially diffusion-alloyed powder in which first copper powder adheres onto a surface of iron powder through partial diffusion; second copper powder; and low-melting point metal powder having a lower melting point than copper,
the partially diffusion-alloyed powder having a maximum particle diameter of 106 μm or less,
the first copper powder of the partially diffusion-alloyed powder having a maximum particle diameter of 10 μm or less.

2. The sintered bearing according to claim 1, wherein the second copper powder has a porous form.

3. The sintered bearing according to claim 1, wherein the sintered bearing comprises a bearing surface formed into a cylindrical shape without a dynamic pressure generating groove.

4. A method of producing a sintered bearing, comprising sintering a green compact comprising: partially diffusion-alloyed powder in which first copper powder adheres onto a surface of iron powder through partial diffusion; second copper powder; and low-melting point metal powder having a lower melting point than copper to produce a sintered bearing,
the partially diffusion-alloyed powder having a maximum particle diameter of 106 μm or less,
the first copper powder of the partially diffusion-alloyed powder having a maximum particle diameter of 10 μm or less.

5. The method of producing a sintered bearing according to claim 4, wherein the second copper powder to be used comprises porous copper powder.

6. A sintered bearing, which is obtained by sintering a green compact comprising: partially diffusion-alloyed powder in which copper powder adheres onto a surface of iron powder through partial diffusion; and copper-based powder including copper as a base,
the copper-based powder to be used comprising porous copper alloy powder including copper alloyed with a low-melting point metal having a lower melting point than copper,
the partially diffusion-alloyed powder having a maximum particle diameter of 106 μm or less,
the copper powder of the partially diffusion-alloyed powder having a maximum particle diameter of 10 μm or less.

7. The sintered bearing according to claim 6, wherein the sintered bearing comprises a bearing surface formed into a cylindrical shape without a dynamic pressure generating groove.

8. A method of producing a sintered bearing, comprising sintering a green compact comprising: partially diffusion-alloyed powder in which copper powder adheres onto a surface of iron powder through partial diffusion; and copper-based powder including copper as a base to produce a sintered bearing,
the copper-based powder to be used comprising porous copper alloy powder including copper alloyed with a low-melting point metal having a lower melting point than copper,
the partially diffusion-alloyed powder having a maximum particle diameter of 106 μm or less,
the copper powder of the partially diffusion-alloyed powder having a maximum particle diameter of 10 μm or less.

9. The method of producing a sintered bearing according to claim 8, wherein the porous copper alloy powder is obtained by annealing copper alloy powder.

10. A sintered bearing, comprising a sintered compact comprising: copper-coated iron powder in which a surface of iron powder is coated with copper; and low-melting point metal powder having a lower melting point than copper,
the iron powder having a particle size of 145 mesh or less.

11. The sintered bearing according to claim 10, wherein the iron powder comprises atomized powder.

12. A method of producing a sintered bearing, comprising the steps of:
compressing raw material powder containing: copper-coated iron powder in which a surface of iron powder is coated with copper; and low-melting point metal powder having a lower melting point than copper to form a green compact; and
sintering the green compact at a temperature higher than a melting point of the low-melting point metal powder and lower than a melting point of copper to obtain a sintered compact,
the iron powder having a particle size of 145 mesh or less.

13. The method of producing a sintered bearing according to claim 12, wherein the iron powder comprises atomized powder.
